(19) United States
(12) Patent Application Publication
(10) Pub. No.: US 2018/0236978 A1
(43) Pub. Date: Aug. 23, 2018

(54) ADAPTABLE END TIP FOR A WIPER BLADE

(71) Applicant: Valeo Systèmes d'Essuyage, Le Mesnil Saint Denis (FR)

(72) Inventors: Stéphane Houssat, Issoire (FR); Guillaume Mouleyre, Issoire (FR); Vincent Gaucher, Issoire (FR)

(73) Assignee: Valeo Systèmes d'Essuyage, Le Mesnil Saint Denis (FR)

(21) Appl. No.: 15/899,628

(22) Filed: Feb. 20, 2018

(30) Foreign Application Priority Data
Feb. 22, 2017 (FR) 1751404

(51) Int. Cl. B60S 1/38

(52) U.S. Cl. CPC B60S 1/3891; B60S 1/3889; B60S 1/3874

(57) ABSTRACT

An end tip (1) for a wiper blade of a screen of a vehicle, comprising a housing extending principally in a first direction and so adapted as to receive equally a first type of stiffening element (3) having a first width or a second type of stiffening element (3) having a second width greater than the first width, characterized in that it includes at least one device for maintaining in position (50) possessing elastic deformation so arranged as to cooperate equally with the first type of stiffening element (3) or the second type of stiffening element (3), the device for maintaining in position (50) being so arranged as to adopt at least an undeformed rest position and an elastically deformed position in which the device for maintaining in position (50) abuts against the second type of the stiffening element (3) in order to secure it in a final installed position.

The field of application of the present invention is that of the wiper blades utilized in motor vehicles. The invention relates more specifically to the tips installed at the end of one of said wiper blades, more particularly in order to assist with the securing of the component parts of the wiper blade.

Motor vehicles are commonly equipped with screen wiper systems in order to ensure wiping and washing of the windscreen and to avoid impairment of the driver's view of his environment. Said screen wiper systems include wiper blades which are conventionally driven by an arm performing an angular reciprocal movement, said blades, of elongated form, themselves being carriers of wiper blades made from an elastic material. Said blades rub against the windscreen and remove the liquid present on the windscreen by bringing it outside the field of view of the driver. The blades are produced either, in a classic version, in the form of articulated mountings which hold the wiper blade at a plurality of discrete points, or, in a more recent version known as “flat blade” (for “lame plate”), of a semi-rigid assembly, which supports the wiper blade over its entire length.

Wiper blades generally comprise a mounting support element for a wiper blade made of rubber adapted to be pressed against the screen to be cleaned, and at least one end tip intended to secure the blade in position in the support element. The blade is introduced by sliding longitudinally into the mounting support element, and it is secured in position by the end tip, which is made integral both with a longitudinal end of the mounting support element and with a longitudinal end of the blade, in order to prevent the longitudinal displacement of the blade in relation to the mounting support element in the course of the reciprocal movement imposed by the arm along the screen to be cleaned.

Blades are already known, furthermore, which include one or a plurality of stiffening elements, more particularly in the form of vertebrae, which extend substantially for the entire length of the blade, and of which the function is to assure the contact of the wiper blade with the windscreen by the spring bias of the stiffening element. Said stiffening elements are additionally configured to assist with the securing of the blade in the end tips, via notches formed in the stiffening elements and having forms that are complementary to locking means carried by the tips.

Each end tip possesses a hollow form comprising a receiving passage configured to receive and to secure at least one end of the stiffening element associated with the blade. Locking means are disposed in the end tip in order to secure the end of said stiffening element in position, and what is sought is a receiving passage adapted to the dimensions of the stiffening element in order to guide the latter correctly during its insertion and to ensure the effectiveness of the locking means. The receiving passage is therefore arranged according to the form and the dimensions of the end of the stiffening element. However, it has emerged that the forms and the dimensions of the ends of the stiffening elements may vary according to the model of wiper blade. Because of this, specific end tips must be utilized for each model of wiper blade.

In this context, the aim of the invention is to propose a standard end tip making it possible to adapt to different wiper blades respectively equipped with a stiffening element with specific dimensions and to provide the most effective possible securing in position for each of its blades.

The invention has as its object an end tip for a wiper blade of a screen of a vehicle comprising a housing extending principally in a first direction and so adapted as to receive equally a first type of stiffening element having a first width or a second type of stiffening element having a second width greater than the first width. The end tip according to the invention includes at least one locking means configured to ensure the retention of the end tip on the blade and at least one device for maintaining in position possessing elastic deformation so arranged as to cooperate equally with the first type of stiffening element or the second type of stiffening element. The device for maintaining in position is so arranged as to adopt at least an undeformed rest position and an elastically deformed position in which the device for maintaining in position abuts against the second type of the stiffening element in order to secure it in a final installed position.

This arrangement makes it possible to receive and retain a stiffening element of a wiper blade selected from among a plurality of available types. Thus, the need to adapt the end tip specifically to the dimensions or to certain dimensions of the stiffening element or of one of its portions is eliminated or, in any event, reduced. In particular, the width of the stiffening element may be more or less great and may, in any event, permit its insertion into the end tip. This is a significant advantage, both for the manufacturer of wiper blades, by limiting the cost of development and manufacture of a plurality of types of end tip, or indeed one type of end tip per type of wiper blade, and also for the final user of the wiper blade wishing to replace an end tip on his vehicle, by limiting the risk that said user will fail to install the end tip corresponding to his wiper blade and that the connection between the two will be deficient, which poses a risk to the user as well as to other road users. The fact that the device for maintaining in position has the ability to adapt elastically to a plurality of types of stiffening elements makes it possible to ensure the correct guiding of the latter during their insertion into the end tip that is common to all these types, and in this way to ensure their correct positioning opposite the one or more locking means that the end tip includes.

The end tip according to the invention advantageously comprises at least any one of the following characterizing features considered in isolation or in combination:
the rest position of the device for maintaining in position corresponds to the position of the device for maintaining in position when no stiffening element is inserted into the end tip, or during the insertion of a first type of stiffening element into the end tip;
the deformed position of the device for maintaining in position corresponds to the position of the device for maintaining in position during the insertion of a second type of stiffening element into the end tip, the second type of stiffening element differing from the first type of stiffening element at least in respect of its greater width;
in the rest position, the device for maintaining in position is so arranged as to serve as a means of guiding for the first type of stiffening element;
in the rest position, the device for maintaining in position extends in parallel or substantially in parallel to the first direction;
the device for maintaining in position extends in the rest position parallel or substantially parallel to the direction of insertion of the stiffening element into the end tip; the arrangement of the device for maintaining in position parallel to the direction of insertion of the stiffening elements allows the risks of breakage of said device for maintaining in position to be lowered at the moment of the insertion and of the contact of the stiffening element with the elastically deformable device for maintaining in position, while acknowledging that the consequence of a suchlike breakage would be to prevent the mounting of the end tip on the stiffening element and on the wiper blade;
the device for maintaining in position is so arranged as to undergo a deformation in contact with a terminal portion of the stiffening element in the housing; said deformation allows the space available to be adjusted in order to receive the terminal portion of the stiffening element; it is this deformation that causes the device for maintaining in position to move from the rest position to the deformed position;
the terminal portion of the stiffening element is defined as the portion of the stiffening element that is inserted first into the end tip. This is the portion of the stiffening element that is in contact with the ribs when the latter are in the deformed position;
the deformation of the device for maintaining in position takes place in a displacement plane, the displacement plane being a plane parallel to the plane defined by the stiffening element; more specifically, the deformation takes place in the displacement plane and in a direction oriented towards the exterior of the end tip; alternatively, the device for maintaining in position is arranged in a plane parallel to the plane defined by the stiffening element, the displacement plane being a plane perpendicular to the plane defined by the stiffening element and in a direction oriented towards the exterior of the end tip;
the device for maintaining in position adopts the form of a rib, of which at least one portion is elastically deformable during the passage of the stiffening element of a first or of a second type; a rib is a volume having the form of a sheet of small thickness; the expression small thickness is intended to denote a rectangular parallelepiped, of which one of the dimensions is much smaller than the two others, for example in a ratio of 1 to 4;
the device for maintaining in position includes two ribs, of which at least one portion is elastically deformable during the passage of the stiffening element of a first or of a second type, and which are disposed parallel to one another; this may be a first type of stiffening element, having a width that is smaller than the dimension between the two ribs, the ribs having in this arrangement a role of guiding the stiffening element, in particular without deformation or free play compensation; with the second type of stiffening element, the width of the stiffening element is greater than the dimension between the two ribs, and the ribs have a role of guiding and free play adjustment by deforming during the insertion of the stiffening element of the second type;
the two ribs are disposed symmetrically to either side of a longitudinal plane of the end tip; the aforementioned longitudinal plane passes in particular through the centre of a groove so arranged as to retain a heel of the blade and through the centre of the housing; the aforementioned longitudinal plane is the median longitudinal plane of the end tip;
the two ribs are spaced apart, in an undeformed original position, by a dimension that is smaller, in a parallel direction, than the dimension of the housing;
the one or more ribs are made in a material or an alloy of materials having elastic properties;
the end tip is delimited by an outer envelope, the one or more ribs extending from an internal face of the outer envelope;
the one or more ribs extend in the bottom of the housing in relation to a direction of insertion of the stiffening element into the tip; in other words, the end tip comprises an opening via which the stiffening element is introduced into the housing and an outer wall which closes the end of the tip on the opposite side from said opening, the rib extending from the outer wall of the end tip;
the outer envelope comprises a covering wall and a bottom wall, the bottom wall being open in order to allow the blade to pass, and the covering wall being disposed on the other side of the bottom wall, the one or more ribs extending from the covering wall of the outer envelope;
the one or more ribs are in the form of an L, when considered in a cross section perpendicular to the plane defined by the stiffening element and parallel to the direction of insertion of the stiffening element into the end tip;
the one or more ribs exhibit a bottom portion protruding from the outer envelope of the tip and a deformable blade extending the bottom portion on the opposite side from said outer envelope;
the deformable blade and the bottom portion that it extends have the same thickness; alternatively, the deformable blade is tapered in relation to the bottom portion that it extends, that is to say the thickness of the deformable blade is smaller than that of the corresponding bottom portion; alternatively, the joint between the deformable blade and the corresponding bottom portion has a thickness that is smaller than the thickness of the deformable blade and the thickness of the bottom portion; alternatively, a bottom portion may include a plurality of deformable blades of small length, aligned with one another and spaced between them;
the locking means includes a tooth, intended to be accommodated in a notch formed on or in the stiffening element; the locking means is elastically deformable, more particularly during the passage of the stiffening element, in order to readopt its original form when the tooth is able to penetrate into a notch disposed on the stiffening element;
a locking means and a device for maintaining in position are arranged in such a way that said device for maintaining in position forms an abutment for the elastic displacement of the locking means;
a locking means and a device for maintaining in position are arranged in such a way as to deform elastically during the passage of the stiffening element in different directions, more particularly perpendicular directions.

The invention also relates to a wiper blade comprising at least one stiffening element as well as a blade intended to be applied against the screen, and at least one end tip according to the preceding embodiment, where the terminal portion of the stiffening element extends into the housing of the end tip. Advantageously, the dimension between the two ribs of the device for maintaining in position is smaller than or equal to the width of the terminal portion of the end tip. In particular, the dimension between the two ribs is equal to the width of the smallest type of stiffening element with which the end tip is so arranged as to cooperate.

The invention also relates to a system for wiping a screen of a vehicle comprising an arm and a wiper blade according to the preceding embodiment.

Other characterizing features, details and advantages of the invention will emerge more clearly from a perusal of the description provided below for information purposes in relation to the drawings, in which:

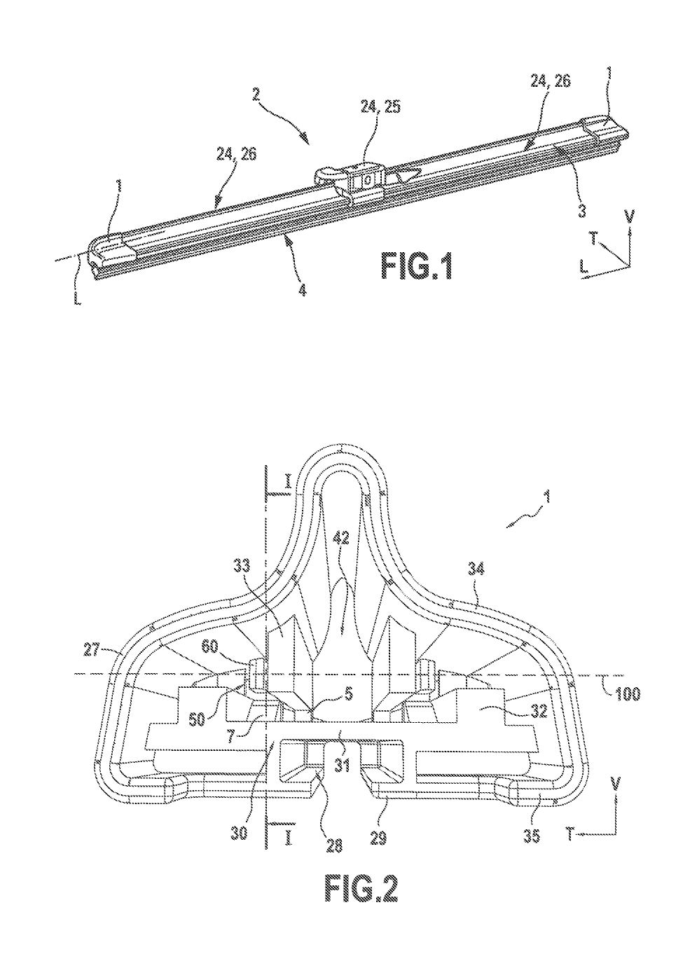

FIG. 1 is a general view, in perspective, of a wiper blade according to the invention,

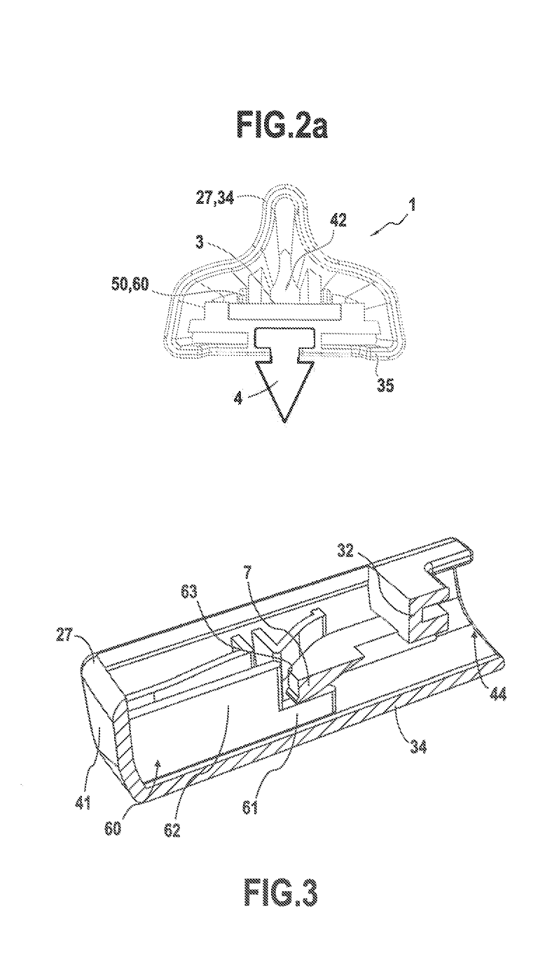

FIG. 2 is a front view in perspective of an end tip equipping a wiper blade as illustrated in FIG. 1, and FIG. 2a is a schematic representation of the tip in FIG. 2 with a stiffening element and a wiper blade of the blade as they are engaged in the end tip,

FIG. 3 is a view in perspective from below of the end tip according to the invention, illustrated partially in the cutting plane I-I illustrated in FIG. 2,

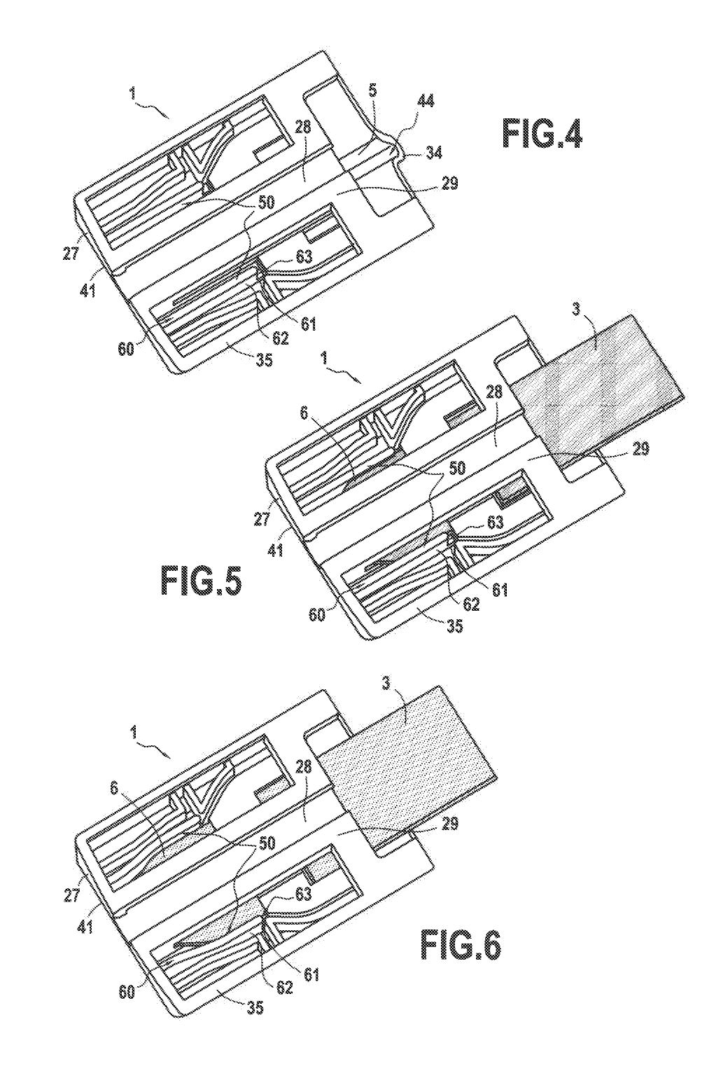

FIG. 4 is a view in perspective, observed from below, of the end tip according to the invention in FIG. 2,

FIGS. 5 and 6 are views in a perspective similar to that in FIG. 4, in which the end tip is illustrated with a stiffening element of a first type (FIG. 5) and with a stiffening element of a second type (FIG. 6).

It should be noted, first of all, that the Figures disclose the invention in a detailed manner in order to implement the invention, said Figures obviously being able to serve to better define the invention if necessary.

In the rest of the description, the designations longitudinal or lateral, above, below, front, rear refer to the orientation of the wiper blade or of the end tip according to the invention. The longitudinal direction L corresponds to the principal axis of the wiper blade in which it extends, whereas the lateral orientations correspond to concurrent lines, in a transverse direction T, that is to say which intersect the longitudinal direction, more particularly perpendicular to the longitudinal axis of the wiper blade in its plane of displacement in rotation along the surface to be cleaned. For the longitudinal directions, the designations outer or inner are assessed in relation to the point of securing the wiper blade on an arm for driving said blade in rotation, the designation inner corresponding to the portion where the arm and a half-blade extend. Finally, the directions referred to as upper or lower correspond to a vertical direction V of the wiper blade, that is to say to orientations perpendicular to the plane of displacement in rotation of the wiper blade, the designation lower including the plane of the surface to be cleaned.

The directions mentioned above are also visible in a trihedron L, V, T represented in the Figures.

With reference initially to FIG. 1, a wiper blade 2 according to the invention can be seen. A suchlike wiper blade 2 is utilized in order to wipe a screen of a vehicle and to move the liquid that is present on said screen outside the field of view of a driver. The wiper blade 2 is constituted of at least one stiffening element 3, a component 24, a rubbing blade 4 and at least one end tip 1 installed on a terminal portion 6 of the stiffening element 3. The stiffening element 3 is a longitudinal support.

The stiffening element 3 may adopt the form of a single flat and elastic metallic strip. According to one alternative, the stiffening element 3 may be formed by two metallic and elastic strips, each engaged in a groove arranged to either side of the blade 4. In the two cases above, in the state of rest, the stiffening element is curved in order to follow the curvature of the windscreen on which the blade bears, in a plane perpendicular to a longitudinal direction of the stiffening element. The function of a suchlike stiffening element is to distribute the pressure forces along the blade 4 and thereby to ensure the effective pressing of the blade against the windscreen.

The terminal portion 6 of the stiffening element 3 is the portion of the stiffening element 3 which enters first into the end tip 1 during the insertion of the stiffening element 3.

The component 24 designates a plurality of types of constituent part of the wiper blade 2. It may be the means of connection 25 intended to attach the wiper blade 2 to an arm for driving said blade in rotation. It may also be one or a plurality of air deflectors 26 attached to the stiffening element 3, and of which the function is to transform the flow of air passing over the wiper blade 2 with a pressure force which presses the blade 4 against the screen.

FIGS. 2 and 4 depict an end tip 1 in perspective. A suchlike end tip 1 exhibits a function of the mechanical holding of the constituent components of the wiper blade 2. Said end tip 1 also exhibits an aesthetic function, since it makes it possible to cover neatly and thereby to conceal the end of the blade 4, the end of the stiffening element 3 and the end of the component 24, more particularly the air deflector 26.

The end tip 1 has an outer envelope 27, of which an upper portion, relative to the orientation of the tip when it is in place on an operating wiper blade on the vehicle, forms a covering wall 34, and a lower portion forms a bottom wall 35. In particular, the covering wall 34 possesses a globally complementary profile to the exterior profile of the air deflector 26. In the interior of an internal volume 42 delimited by the outer envelope 27, the end tip 1 comprises a housing 5 for receiving the stiffening element 3. The portion of the stiffening element 3 received in the housing 5 is the terminal portion 6. Represented in FIG. 2a is a schematic representation of the location of the stiffening element in the receiving housing 5. The end tip 1 also comprises a groove 28, of which the function is to retain a heel of the blade 4 mechanically, likewise represented schematically in FIG. 2a. Said groove 28 is arranged in the bottom wall 35, thus being open towards the exterior, said opening being delimited by two clasps 29 which extend longitudinally along the end tip 1 and which form respectively an abutment preventing the vertical clearance of the blade and more particularly of the heel.

The groove 28 and the housing 5 are formed in the interior of the internal volume 42 delimited by the outer envelope 27, being delimited by an ensemble of walls that are integral with the outer envelope and together form a body 30 of the end tip 1.

The housing 5 is formed in the body 30 of the end tip 1, in the vicinity of the groove 28, on the opposite side from the opening of the groove towards the exterior, in a direction perpendicular to a plane of extension of the groove 28. It extends in a general plane of extension parallel to the plane of extension of the groove 28. The housing 5 is delimited by a support wall 31, which also plays a part in delimiting not only the housing 5 but also the groove 28, and at least two lateral edges 32, as well as by at least one flank 33, and more particularly two flanks 33, disposed facing towards the support wall 31. Said flanks 33 are each formed by an edge that is integral with the outer envelope 27. The flanks 33 extend in planes perpendicular to a plane in which the support wall 31 extends, and thus parallel to planes of extension of the lateral edges 32.

The outer envelope 27 of the end tip 1 comprises an outer wall 41 which encloses longitudinally the internal volume 42 of the tip, on the side opposite from an opening 44 arranged in the inner longitudinal end. Said opening 44 permits the insertion of the stiffening element 3 and of the wiper blade of the associated blade into the end tip.

As will be described below in more detail, at least two types of stiffening elements 3, distinguishable by their dimensions and more particularly by their width, that is to say the dimension contained between the two lateral edges 32 of the housing 5, may be inserted into the housing 5 of the end tip 1.

The end tip 1 also comprises a locking means 7 visible in FIG. 2. This is a means of which the function is to ensure the retention of the end tip 1 on the wiper blade 2 in the longitudinal direction, in order to prevent it from being displaced towards the exterior of the wiper blade 2, in the longitudinal direction of the latter. Said locking means 7, for example, takes the form of a tooth or of a tab, arranged at the end of which is a tooth, intended to be accommodated in a notch formed on or in the stiffening element 3. The locking means 7 is formed in a material having elastic properties and it is configured to deform elastically during the passage of the terminal portion 6 of the stiffening element 3 into the end tip 1, and to readopt its original form when the tooth is able to penetrate into the notch.

A device for maintaining in position 50 is provided in the internal volume of the end tip 1 in order to facilitate the guiding of the end 6 of the stiffening element 3 regardless of its type, and to ensure its position in order for the locking to be carried out correctly. The device for maintaining in position 50 is adapted to adopt at least one rest position and one deformed position.

In the rest position, which is the position of the device for maintaining in position 50 when no stiffening element 3 is inserted into the end tip 1, or if necessary during the insertion of a first type of stiffening element 3 into the end tip 1, the device for maintaining in position 50 extends parallel or substantially parallel to the direction of insertion of the stiffening element 3 into the housing 5 of the end tip 1.

Thus, in the rest position, the device for maintaining in position 50 is so arranged as to serve as a means for guiding for a stiffening element 3 of the first type.

The device for maintaining in position 50 according to the invention is configured to deform, if necessary, under the effect of the introduction into the end tip of a stiffening element that is wider than the standard stiffening element, having elastic properties which assist with the gripping of said stiffening element and which prevent its displacement in the interior of the tip.

In the illustrated example, the device for maintaining in position 50 includes two ribs 60 that are elastically deformable, at least in part, for the passage of the stiffening element, said ribs being more particularly integral with the outer envelope 27 of the end tip 1, by extending parallel to one another in their rest position, that is to say their original position in the absence of deformation stressing of the stiffening element.

More specifically, each rib 60 is integral with the covering wall 34 of the outer envelope 27 and extends towards the interior of the tip protruding from the internal face of said covering wall 34. Said two ribs 60 are parallel to one other. The general plane of extension of one rib 60 is thus parallel to that of another rib 60. Furthermore, the ribs 60 are formed symmetrically in relation to a longitudinal plane, and more particularly the median longitudinal plane, of the tip. Said median longitudinal plane, passing more particularly at the centre of the groove 28 and at the centre of the housing 5, separates the end tip 1 into two internal halves, which are symmetrical in relation to one another, each rib 60 occupying the same position and extending in the same manner in its respective half. It will be appreciated that the definition of a suchlike median plane extends in relation to the internal components of the tip and that it is applicable to tips, of which the outer envelope is not only symmetrical but also asymmetrical.

It will be appreciated that, without departing from the context of the invention, the device for maintaining in position 50 could comprise a single rib in accordance with what has been described and will be described, that is to say a rib arranged in such a way as to be flexible and deformable elastically in contact with one end of a stiffening element, irrespective of the type and more particularly the dimensions of said stiffening element, having a rigid wall on the other side of the median longitudinal plane of the tip facing towards said single deformable rib 60. The stiffening element inserted into the housing of an end tip thus arranged is guided by the rigid wall and by the deformable rib of the device for maintaining in position, only the rib deforming in order to press the stiffening element against the rigid wall.

A more detailed description of the arrangement and the function of this device for maintaining in position 50 is given below outlining the device with two ribs, it being noted that this would be equivalent to one rib.

Each rib 60 extends longitudinally along an internal face of the covering wall 34, from the outer wall 41. Each rib 60 is thus in contact with an internal face of the outer envelope 27 of the end tip via two of its sides.

The ribs 60 are configured in the form of an “L” in a plane perpendicular to the plane defined by the stiffening element 3 and parallel to the direction of insertion of the stiffening element 3 into the housing 5. In others words, the rib 60 adopts the form of a wall of small thickness, extending in the internal volume of the tip from the covering wall 34, having a bottom portion 61 which extends protruding directly from the covering wall and a portion which extends it at a distance from the covering wall and which forms a deformable blade 62. The longitudinal dimension of the deformable blade 62 is smaller than the longitudinal dimension of the bottom portion 61, said two components of the rib all being based on the outer part 41. In this way, the bottom portion 61 forms a longitudinal protrusion in the direction of the opening 44. The “L”-shaped form of the ribs 60 is particularly visible in FIG. 3.

A shoulder is formed between the bottom portion 61 and the deformable blade 62. The shoulder edge 63 exhibits a curved profile, of which the benefit is described below in the detailed description of the cooperation of the end tip according to the invention with stiffening elements having a plurality of dimensions. It is also possible to describe the benefit of the vertical dimension of the deformable blade, which is greater than that of the bottom portion, and which imparts to it a flexibility which has the potential to permit an elastic deformation in the transverse direction.

Characterizing features relative to the position of said ribs, and more particularly in relation to the position of a corresponding locking means 7, can be noted in a second step.

As is visible more particularly in FIG. 2 and in FIG. 3, a rib 60 of the device for maintaining in position 50 and a corresponding locking means 7 are disposed in the same plane that is parallel to the longitudinal median plane of the tip described above. A rib 60 of the device for maintaining in position 50 is thus disposed transversely, at least in part, above the locking means 7, in such a way as to form an abutment for the elastic displacement of the locking means 7 when the latter deforms in order to allow the stiffening element to pass through before sliding into the corresponding notch.

It will be appreciated that the protrusion formed by the bottom portion 61 is so arranged as to collaborate with the locking means 7 in order to ensure the retention of the end tip 1 on the wiper blade 2 in the longitudinal direction, by preventing the locking means 7 from exiting from the notch. More precisely, said protrusion comes to rest above the locking element when the tip is mounted on a wiper blade in the functional position of the latter.

Furthermore, the shoulder, and more particularly the shoulder edge 63, is disposed facing towards locking means 7, retracted longitudinally towards the outer wall 41 of the end tip, in such a way that the deformable blade 62 extends behind said locking means 7. It will be appreciated that, in this arrangement, the stiffening element 3 during its insertion is directly in contact with the deformable blade 62 after having deformed the locking means 7 during its passage.

The ribs 60 of the device for maintaining in position 50 are also positioned in relation to the housing 5 through which the stiffening elements 3 pass. As already mentioned previously, the ribs 60 are formed symmetrically in relation to the median longitudinal plane of the tip passing through the centre of the housing 5. And it should be noted that the spacing from one rib 60 to the other is smaller than the width, that is to say the transverse dimension parallel to the orientation of the dimension between the ribs, of the housing. Furthermore, the deformable blade 62 extends for a height, that is to say at a distance from the covering wall 34, such that it extends into the bottom of the housing 5 and at the height thereof. In this way, and as will be described below, a stiffening element 3 passing through the housing 5 and having a width equal to the width of the housing 5 enters into contact with each of the deformable blades 62 of the ribs 60.

Each rib 60 of the device for maintaining in position 50 is arranged in order to collaborate with the terminal portion 6 of the stiffening element 3 by permitting its insertion into the housing 5 irrespective of its width. As may be visible in FIGS. 5 and 6, the stiffening element 3, whether of a first type (FIG. 5) or of a second type (FIG. 6), comprises a first face that is visible in said Figures and is oriented towards the screen of the vehicle to be cleaned, and a face opposite said first face. The dimension between said two faces constitutes the thickness of the stiffening element 3, and it may vary depending on whether consideration is being given to a first type of stiffening element that is less wide, or to a second type of stiffening element that is wider. The width of the stiffening element 3 is the residual dimension, that is to say that between the faces perpendicular to those defining the length of the stiffening element 3 and those defining its thickness, and it is visible in FIGS. 5 and 6 that said dimension varies depending on whether the first or the second type of stiffening element is being considered.

A method of installing a wiper blade 2 equipped with an end tip 1 is now described, in order to describe in more detail the cooperation of the device for maintaining in position 50 with a stiffening element 3 regardless of its type.

According to a non-exhaustive example of a suchlike method, illustrated in FIG. 5, the insertion of the terminal portion 6 of a first type of stiffening element 3 into the end tip 1 is effected by a longitudinal translation from the opening 44 towards the outer wall 41 in the housing 5. The terminal portion 6 of the first type of stiffening element penetrates into the housing 5, deforms during its passage through the locking means 7 and then arrives at the level, in the longitudinal direction, of the shoulder edge 63 of the ribs 60.

The width of a stiffening element of a first type is smaller than the width of the housing 5 and substantially equal to the distance of the ribs 60 from one another when they are at rest, that is to say parallel to the longitudinal direction. The flexibility of the deformable blades 62 of the ribs permits an adjustment in the transverse position of the stiffening element of a first type, in such a way as to centre said stiffening element on the longitudinal median plane. In fact, the stiffening element, if it was not centred during its insertion, will deform one of the two ribs by separating it from the other and will stress only that rib of which the elastic properties seek to bring the stiffening element back towards the other rib. The rounded edge of the shoulder edge 63 facilitates the separation of the deformable blade 62 in contact with the terminal portion 6 of the stiffening element 3.

This results in the recentering of the stiffening element, which enables the locking means 7 to be made to cooperate for certain with the one or more corresponding notches disposed on the stiffening element when the stiffening element has been inserted sufficiently into the end tip. And it results in the terminal portion 6 being gripped between the ribs which between them support the stiffening element of the first type transversely, having a width equal to or slightly greater than the distance between the ribs.

It should be noted that the device for maintaining in position 50 is configured in such a way that the one or more ribs 60 are deformed elastically in a first direction, in this case transversely with reference to the previously defined trihedron, and in such a way that said first direction is distinct, and in the case described here perpendicular, to the direction of deformation of the tab forming a locking means 7.

In FIG. 6, an end tip 1 can be seen that is identical to that disclosed in the first example of a method of installation, receiving a terminal portion 6 of a second type of stiffening element 3, similar in form to that disclosed in the first example of a method of installation, but with a greater width.

In accordance with the foregoing, during the introduction of the stiffening element 3 into the end tip 1, the terminal portion 6 enters into the housing 5 via the opening 44, deforming the locking means 7 elastically as it passes through. The width of the stiffening element of the second type is substantially equal to the width of the housing 5, in such a way that the stiffening element is already centred during its insertion. This results in the simultaneous contact of the terminal portion 6, more specifically its front face, with each of the ribs 60 of the device for maintaining in position 50, and more specifically their shoulder edge 63. The incoming translation of the stiffening element 3 continues and deforms the ribs 60 progressively. It is the deformation of the ribs, and more specifically the separation of the ribs from one another, during the passage of the stiffening element 3 which causes the device for maintaining in position 50 to pass into a deformed position. Said deformation takes place in a displacement plane 100, which is a plane parallel to the plane defined by the stiffening element 3, which separates the ribs 60 from one another. The elasticity of the deformable blades tends to bring the stiffening element back towards the opposite rib, and it will be appreciated that the centring of the stiffening element in a final installed position is assured in this way, with the stiffening element being gripped by each of the ribs. It is also the elastic return of the deformed ribs 60 which grips the stiffening element and which ensures its retention in position.

The deformation is made possible by the form of the deformable blade 62. The deformable blade 62 is arranged in the extension of the bottom portion 61, on the opposite side from the outer envelope 27 from which said bottom portion 61 extends. Thus, from the outer envelope 27, the rib 60 first comprises the bottom portion 61, and then the deformable blade 62. The bottom portion 61 is thus in contact with the outer envelope 27, the deformable blade 62 being in contact with the bottom portion 61. Variant embodiments of the ribs 60, differing in respect of the arrangement of the bottom portion 61 and/or of the deformable blade 62 constituting it, may nevertheless be envisaged. Certain of said variants have been disclosed earlier in the application.

Regardless of the type of stiffening element 3 utilized by the wiper blade 2, the zone of contact between each rib 60 and the stiffening element 3, in the final positions illustrated in FIGS. 5 and 6, remains the same. In others words, regardless of whether the deformation of the ribs 60 is inexistent or less important (FIG. 5), or even if it is at the limit of causing a plastic deformation of the ribs 60 (FIG. 6), the final installed position generates a contact between a deformable blade 62 of the rib 60 and a lateral edge of the stiffening element 3.

The wiper blade 2 thus equipped with an end tip 1 may now be mounted on a driving arm by means of a connector. The driving arm is set in movement by a motor in such a way as to permit the wiper blade 2, in the course of its displacement, to wipe in an effective manner the screen of a vehicle equipped with a suchlike system.

The above description clearly explains how the invention makes it possible to achieve the objectives that it has set itself and, more particularly, to propose an end tip 1 capable of receiving a plurality of types of stiffening element 3, differing more particularly in respect of their width, while securing their installation in the end tip 1.

The invention relates more particularly to an end tip, in the interior of which one or a plurality of elastically deformable ribs exhibit a bottom portion protruding from an outer envelope of the tip and a deformable blade extending the bottom portion on the opposite side from said outer envelope.

Of course, various modifications may be made by a person skilled in the art to the end tip which has been described by way of non-exhaustive example, as soon as at least one device for maintaining in position, so arranged as to limit a displacement of the terminal portion of the stiffening element regardless of whether it is of a first or of a second type, has been implemented. The end tip according to the invention may be utilized more particularly with a stiffening element having a width equivalent to the dimension between the two ribs and having a role of guiding and wedging the stiffening element, and the ribs exhibiting in the assembled position a slight deformation with free play compensation. In any event, the invention should not be limited to the embodiment described specifically in this document, and extends in particular to any equivalent means and to any technically effective combination of said means.

1. An end tip for a wiper blade of a screen of a vehicle, comprising:
a housing extending principally in a first direction and configured to receive equally a first type of stiffening element having a first width or a second type of stiffening element having a second width greater than the first width;
at least one locking means configured to ensure the retention of the end tip on the blade; and
at least one device for maintaining in position possessing elastic deformation arranged to cooperate equally with the first type of stiffening element or the second type of stiffening element,
the device for maintaining in position being arranged to adopt at least an undeformed rest position and an elastically deformed position in which the device for maintaining in position abuts against the second type of the stiffening element in order to secure the second type of stiffening element in a final installed position.

2. The end tip according to claim 1, in which the device for maintaining in position in the rest position is so arranged as to serve as a means of guiding for the first type of stiffening element.

3. The end tip according to claim 1, in which the device for maintaining in position is so arranged as to undergo deformation in contact with a terminal portion of a stiffening element, the deformation of the device for maintaining in position taking place in a displacement plane, the displacement plane being parallel to the plane defined by the stiffening element.

4. The end tip according to claim 1, in which the device for maintaining in position adopts the form of at least two ribs disposed parallel to one another, of which at least one portion is elastically deformable for the passage of the stiffening element of a first or of a second type.

5. The end tip according to claim 4, in which the at least one rib is made from a material or an alloy of materials having elastic properties.

6. The end tip according to claim 4, in which the end tip is delimited by an outer envelope, the at least one rib extending from an internal face of the outer envelope.

7. The end tip according to claim 4, in which the one or more ribs extend in the bottom of the housing in relation to a direction of insertion of the stiffening element into the tip.

8. The end tip according to claim 4, in which the outer envelope comprises a covering wall and a bottom wall, the bottom wall being open in order to allow the blade to pass through, and the covering wall being disposed on the opposite side from the bottom wall, the at least one rib extending from the covering wall of the outer envelope.

9. The end tip according to claim 4, in which the at least one rib is in the form of an L, when considered in a cross section perpendicular to the plane defined by the stiffening element, and is parallel to the direction of insertion of the stiffening element into the end tip.

10. The end tip according to claim 4, in which the at least one rib has a bottom portion protruding from the outer envelope of the tip and a deformable blade extending the bottom portion on the opposite side from said outer envelope.

11. The end tip according to claim 1, in which the locking means includes a tooth accommodated in a notch formed on or in the stiffening element.

12. The end tip according to claim 1, in which the locking means and the device for maintaining in position are arranged so that said device for maintaining in position forms an abutment for the elastic displacement of the locking means.

13. The end tip according to claim 1, in which the locking means and the device for maintaining in position are arranged in such a way as to deform elastically for the passage of the stiffening element in different directions, more particularly perpendicular directions.

14. A wiper blade comprising:
at least one stiffening element;
a blade configured to be applied against the screen; and
at least one end tip according to claim 1,
wherein the terminal portion of the stiffening element extends in the housing of the end tip.

15. A system for wiping a screen of a vehicle comprising an arm and a wiper blade according to claim 14.
